(19) United States
(12) Patent Application Publication
(10) Pub. No.: US 2023/0099099 A1
(43) Pub. Date: Mar. 30, 2023

(54) ELECTRIC MOTOR MODULE

(71) Applicant: Naoki Christoph OTANI, Aichi (JP)

(72) Inventor: Naoki Christoph OTANI, Aichi (JP)

(73) Assignee: NIDEC MOBILITY CORPORATION, Aichi (JP)

(21) Appl. No.: 18/073,445

(22) Filed: Dec. 1, 2022

(30) Foreign Application Priority Data
Dec. 2, 2021 (JP) 2021-196141

(51) Int. Cl. H02K 5/22; H02K 7/116; H02K 11/215

(52) U.S. Cl. CPC H02K 5/225; H02K 7/116; H02K 11/215; H01R 12/716

(57) ABSTRACT

An electric motor module includes: an electric motor; a printed circuit board; a gear that performs conversion such that an output shaft extends is orthogonal to a rotating shaft of the electric motor; a storage portion that houses at least the electric motor and the gear; and a connector storage portion that houses the connector and attached to an opening of the storage portion. A connection portion between the opening and the connector storage portion is inclined with respect to the rotating shaft on a plane perpendicular to the output shaft. The printed circuit board includes: a first portion parallel to the rotating shaft on the plane; and a second portion extending from one end of the first portion toward the rotating shaft. A connector is disposed at another end of the first portion, and a terminal is disposed in the second portion.

### CROSS-REFERENCE TO RELATED APPLICATIONS

This application is based upon and claims the benefit of priority from Japanese Patent Application No. 2021-196141, filed on Dec. 2, 2021; the entire contents of which are incorporated herein by reference.

### FIELD

One or more embodiments of the present invention relate to an electric motor module.

### BACKGROUND

Conventionally, there has been known a technique related to a module that includes an electric motor as a drive source for power windows, sliding doors, a sunroof, power seats, and the like in a vehicle, and integrally houses a board and the like inside a housing. For example, JP2014-217221A discloses a motor capable of ensuring the sealing between a gear housing and a board case without increasing the number of components. In this motor, a connector mounting portion and a connector housing communicate with each other through opening portions, and the edge portion of each opening portion is inclined with respect to the assembling direction of the connector housing, and a seal member is interposed between the opening edge portions. The connector mounting portion is integrally formed with an inclination regulating portion extending into the connector housing through each opening portion and abuts on the inner surface of the connector housing, and the inclination regulating portion is configured to regulate the inclination of the connector housing to the connector mounting portion.

JP2011-125191A discloses a motor including a control circuit module that enables miniaturization. This motor includes a control circuit module assembled in the housing by being inserted into an insertion hole formed in the housing. The control circuit module includes a power line connection terminal portion electrically connected to a motor body, a power supply connector portion exposed outside the housing for electrical connection with the outside, and a control circuit portion disposed between a power line connection terminal portion and a connector portion and controlling rotation of the motor body, and the power line connection terminal portion of the control circuit module is provided on the opposite side to the connector portion with respect to a rotating shaft.

JP2006-034073A discloses a motor capable of efficiently dissipating heat generated by a control circuit member housed in a gear housing to the outside. This motor includes a motor body having a rotating shaft, a gear housing that is assembled to the motor body and houses a worm and a worm wheel for decelerating the rotation of a rotating shaft, and a control circuit member having electric circuit components and housed in the gear housing. An opening portion is formed in the gear housing so that a part of the control circuit member projects outside the gear housing, and a metal cover including a storage portion for housing a part of the control circuit member projecting outward for closing the opening portion is attached.

JP2004-187428A discloses a motor capable of reducing the number of components and man-hours for assembly. In this motor, a board storage case is integrally formed with a board storage portion for housing a control circuit board and a cover portion for closing the opening portion of a worm wheel storage portion.

JP2004-112887A discloses a motor in which a circuit board is inserted into a gear housing along the planar direction of the board. In this motor, in a case where a connector portion is positioned on the tip portion side of the circuit board in the insertion direction, the motor smoothly houses the circuit board in the gear housing without interfering with other motor components while preventing the increase in size of the gear housing. In the gear housing, a board storage portion into which the circuit board is inserted along the planar direction of the board is formed, and the connector portion in which a terminal is fixed to a part positioned on the tip portion side in the board insertion direction of the board storage portion is integrally constituted. The circuit board is provided with a terminal connection terminal for connection with a terminal of the connector portion on the tip portion side in the insertion direction.

### SUMMARY

One or more embodiments of the present invention provide an electric motor module that can be miniaturized by suppressing the thickness of a power passing through the gear from the electric motor in the direction of the final output shaft and the expansion of the power in a plane perpendicular to the final output shaft.

In one or more embodiments of the present invention, there is provided an electric motor module including: an electric motor; a printed circuit board on which a connector for receiving electric power from an outside and a terminal for supplying the electric power to the electric motor are mounted; a gear that performs conversion such that an axial direction of an output shaft extends in a direction orthogonal to an axial direction of a rotating shaft of the electric motor; a storage portion that houses at least the electric motor and the gear; and a connector storage portion that houses at least the connector, the connector storage portion being attached to an opening of the storage portion, wherein a connection portion between the opening and the connector storage portion is inclined with respect to the rotating shaft on a plane perpendicular to the output shaft, wherein the printed circuit board includes: a first portion parallel to the rotating shaft on the plane perpendicular to the output shaft; and a second portion extending from one end of the first portion toward the rotating shaft, wherein the connector is disposed at another end of the first portion, and wherein the terminal is disposed in the second portion.

According to this, since the printed circuit board has a roughly L shape including the first portion parallel to the rotating shaft and the second portion extending from the first portion toward the rotating shaft, the connection portion between the connector storage portion for housing the connector mounted on the printed circuit board and the storage portion for housing the motor is inclined with respect to the rotating shaft, there is provided an electric motor module that can be miniaturized by suppressing the expansion of the power passing through the gear from the electric motor on a plane perpendicular to the final output shaft.

Further, the direction of insertion into the connector in the connector storage portion and the rotating shaft may be parallel to each other.

According to this, since the direction of insertion into the connector and the rotating shaft are parallel, the thickness of the gear in the direction of the final output shaft can be suppressed and miniaturized.

Further, the end portion of the second portion may include a sensor that is inserted through the opening and extends to the vicinity of the rotating shaft, the sensor being configured to detect rotation of the electric motor.

According to this, the end portion of the second portion extends to the vicinity of the rotating shaft, and by providing the rotation sensor, a single printed circuit board can have a plurality of functions, and miniaturization is possible.

As described above, according to one or more embodiments of the present invention, it is possible to provide an electric motor module that can be miniaturized by suppressing the thickness of a power passing through the gear from the electric motor in the direction of the final output shaft and the expansion of the power on a plane perpendicular to the final output shaft.

### BRIEF DESCRIPTION OF DRAWINGS

FIG. 1 is a front view of an electric motor module according to a first embodiment of the present invention;

FIG. 2A is a perspective view of the electric motor module according to the first embodiment of the present invention from the lower left front, and FIG. 2B is a perspective view thereof from the upper left rear;

FIG. 3A is a side view of a storage portion in which a connector storage portion is removed in the electric motor module according to the first embodiment of the present invention,

FIG. 3B is a perspective view of the storage portion from the upper left front, in which the connector storage portion is removed, and FIG. 3C is a perspective view of the storage portion from the upper left rear, in which the connector storage portion is removed;

FIG. 4A is a side view of the connector storage portion as seen from the storage portion side in the electric motor module according to the first embodiment of the present invention, and FIG. 4B is a perspective view of the connector storage portion from the lower right front;

FIG. 5A is a perspective view of the electric motor module according to the first embodiment of the present invention, in which the connector storage portion is removed and a printed circuit board is attached to the storage portion, and FIG. 5B is a perspective view of the electric motor module in which the printed circuit board is attached to the connector storage portion;

FIG. 6A is a cross-sectional view of the electric motor module according to the first embodiment of the present invention, taken along the A-A cross section in FIG. 6B, and FIG. 6B is a front view of the electric motor module;

FIG. 7 is a view showing how the printed circuit board is attached to the connector storage portion in the process of assembling the electric motor module according to the first embodiment of the present invention; and

FIG. 8 is a view showing how the connector storage portion to which the printed circuit board is attached is attached to the storage portion in the process of assembling the electric motor module according to the first embodiment of the present invention.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, an embodiment of the present invention will be described with reference to drawings.

### First Embodiment

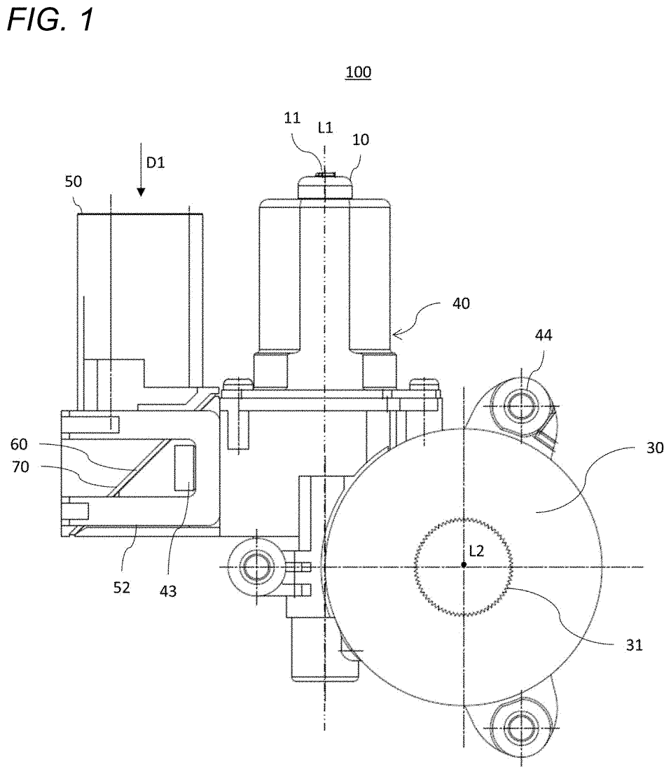

An electric motor module 100 according to the present embodiment is described with reference to FIGS. 1 to 8. The electric motor module 100 is mounted in a vehicle and used to drive a power window, a sliding door, a sunroof, a power seat, and the like. The electric motor module 100 is modularized by integrally housing an electric motor 10 for driving the power window, the sliding door, the sunroof, the power seat, and the like, a gear 30 having a final output shaft 31, a printed circuit board 20, and the like therein. For example, in a case where the electric motor module 100 is for driving a power window, the electric motor module 100 is attached inside the door by using an installation hole 44 and raises and lowers the window glass through a window regulator.

The electric motor module 100 includes the electric motor 10 that serves as a drive source, the gear 30 that performs conversion such that the axial direction of the final output shaft 31 extends in a direction orthogonal to the axial direction of a rotating shaft 11 of the electric motor 10, the printed circuit board 20 on which a connector 23 for receiving electric power from the outside and an electronic component 26 for driving the electric motor 10 from the electric power are mounted, a storage portion 40 and a connector storage portion 50 that house the same, and a mounting portion 52 connecting the storage portion 40 and the connector storage portion 50. The gear 30 is housed inside the storage portion 40 and is not shown in the drawings of this specification.

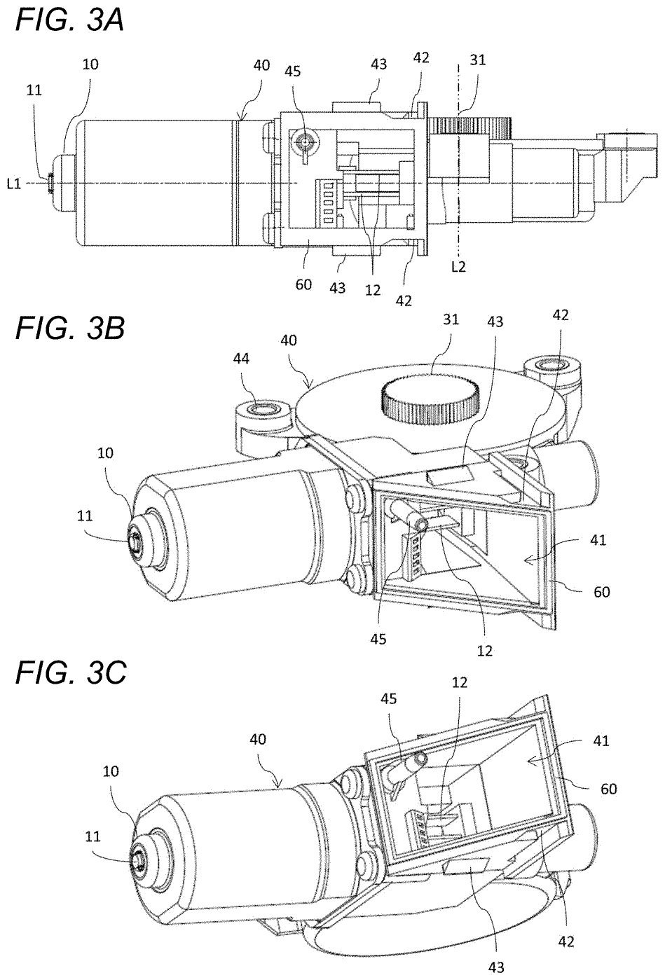

The electric motor 10 is a DC motor, and may be with or without a brush, and is not particularly limited. In the electric motor 10, the rotating shaft 11 extends in the vertical direction from a yoke housing (not shown) housed in the storage portion 40 as shown by the two-dot chain line in FIG. 1 (shaft line L1 of the rotating shaft 11), the upper end of the rotating shaft 11 projects from the storage portion 40, and a worm (not shown) is attached to the lower end (not shown). The electric motor 10 includes two plate-like electrodes 12 in the vicinity of the rotating shaft 11 for receiving electric power supply from the outside through the printed circuit board 20 (FIGS. 3A to 3C). A magnet (not shown) is attached to the rotating shaft 11 at a position corresponding to a rotation detection sensor 25, which will be described later.

The gear 30 includes a worm wheel (not shown) that meshes with the worm, and a final output shaft 31 that is directly connected to the center of the worm wheel, and is rotatably housed in the storage portion 40. The worm wheel decelerates the rotation of the rotating shaft 11 and transmits high torque to the final output shaft 31, and the final output shaft 31 drives the regulator. The gear 30 performs conversion such that the final output shaft 31 extends in an axial direction (shaft line L2: direction perpendicular to the paper surface in FIG. 1 or vertical direction parallel to the paper surface in FIG. 3A) orthogonal to the axial direction of the rotating shaft 11 (shaft line L1: vertical direction parallel to the paper surface in FIG. 1 or horizontal direction parallel to the paper surface in FIG. 3A).

The storage portion 40 integrally houses the electric motor 10 and the gear 30, and includes a storage portion opening 41 for connecting with the connector storage portion 50 from a direction orthogonal to the direction of the shaft line L1 of the rotating shaft 11. The storage portion opening 41 is provided on the side opposite to the gear 30 across the rotating shaft 11 of the electric motor 10. In a case where the storage portion 40 is connected to the connector storage portion 50 as described later, the storage portion 40 houses a part of the printed circuit board 20 between the storage portion opening 41 and the rotating shaft 11.

The storage portion opening 41 is a rectangle having one pair of opposing sides parallel to the final output shaft 31 and the other pair of opposing sides inclined with respect to the rotating shaft 11 on a plane perpendicular to the final output shaft 31. In FIG. 1, the storage portion opening 41 is inclined to be closer to the rotating shaft 11 at the top and farther from the rotating shaft 11 as the storage portion opening 41 goes downward, and receives the force applied in an insertion direction D1 of a connector cable (not shown) from upward to downward.

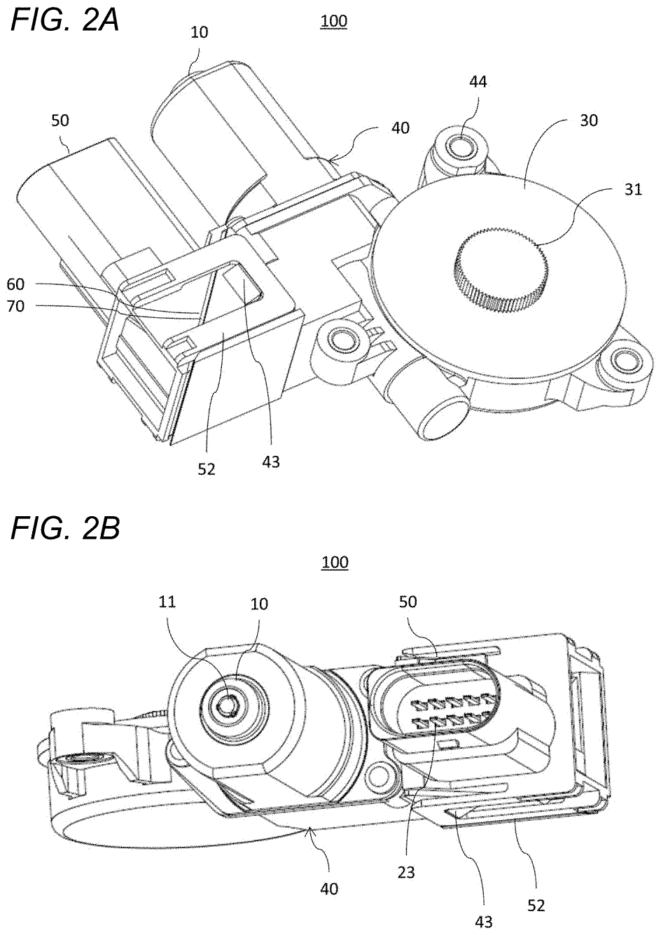

The connector storage portion 50 houses the connector 23 mounted on the printed circuit board 20 by exposing the connector 23 to the outside so that the tip thereof can be connected to the connector cable (FIG. 2B). A connector storage portion opening 51 is formed at the other end on the opposite side of one end where the connector 23 of the connector storage portion 50 is exposed. As with the storage portion opening 41, the connector storage portion opening 51 is a rectangle having one pair of opposing sides parallel to the final output shaft 31 and the other pair of opposing sides inclined with respect to the rotating shaft 11 on a plane perpendicular to the final output shaft 31, has the same shape and size as the storage portion opening 41, and is attached to the storage portion opening 41. Since the storage portion opening 41 and the connector storage portion opening 51 are inclined in this way, the area of each opening is increased, and as will be described later, the printed circuit board 20 can be easily assembled through both openings.

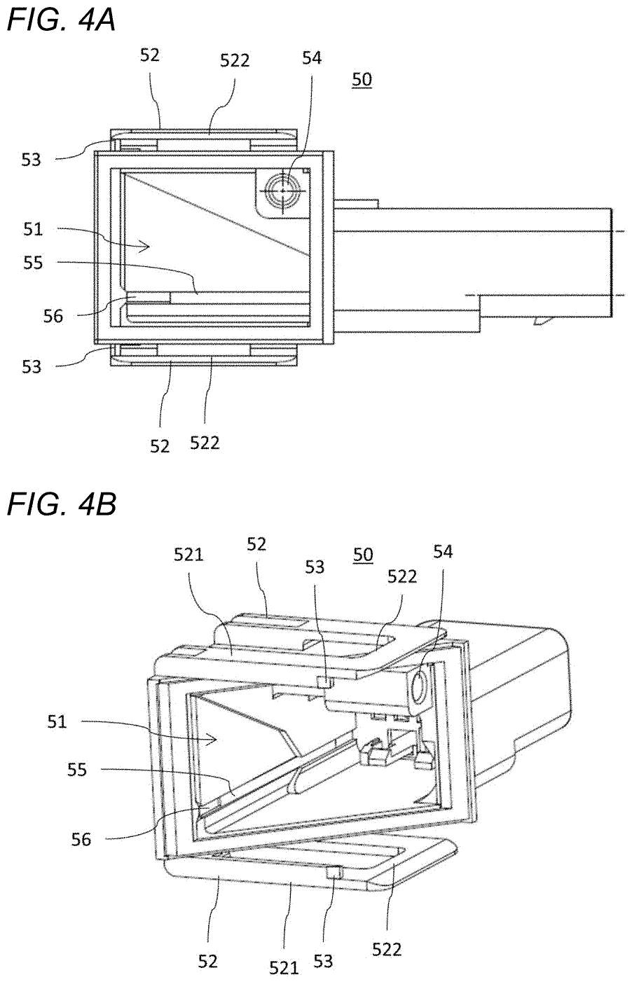

The connector storage portion 50 includes a slide groove 55 for sliding the edge of the printed circuit board 20 into the inside in the longitudinal direction for attachment, and a positioning recessed portion 56 for positioning the printed circuit board 20 in the vicinity of the connector storage portion opening 51 of the slide groove 55 (FIGS. 4A and 4B). As a result, when the printed circuit board 20 is inserted into the connector storage portion 50 for attachment, the printed circuit board 20 can be easily attached, and there is no rattling after attachment.

In a case where the connector storage portion 50 is attached to the storage portion 40, it is preferable that the insertion direction D1 of the connector storage portion 50 into the connector 23 and the rotating shaft 11 are parallel. Since the insertion direction D1 into the connector 23 and the rotating shaft 11 are parallel to each other, compared with the case where the insertion direction is in the thickness direction of the gear 30, the thickness of the gear 30 in the direction of the final output shaft (shaft line L2 direction) is suppressed to be miniaturized. The edge portion of the storage portion opening 41 and the edge portion of the connector storage portion opening 51 are connected by a sealing 60 interposed therebetween to improve the watertightness of a connection portion 70 between the two. The sealing 60 is made of, for example, an elastic elastomer and is formed into a rectangular ring shape matching the shape of both openings. The connection portion 70 is inclined with respect to the rotating shaft 11 on a plane perpendicular to the final output shaft 31 so as to receive the force applied in the insertion direction D1 of the connector cable.

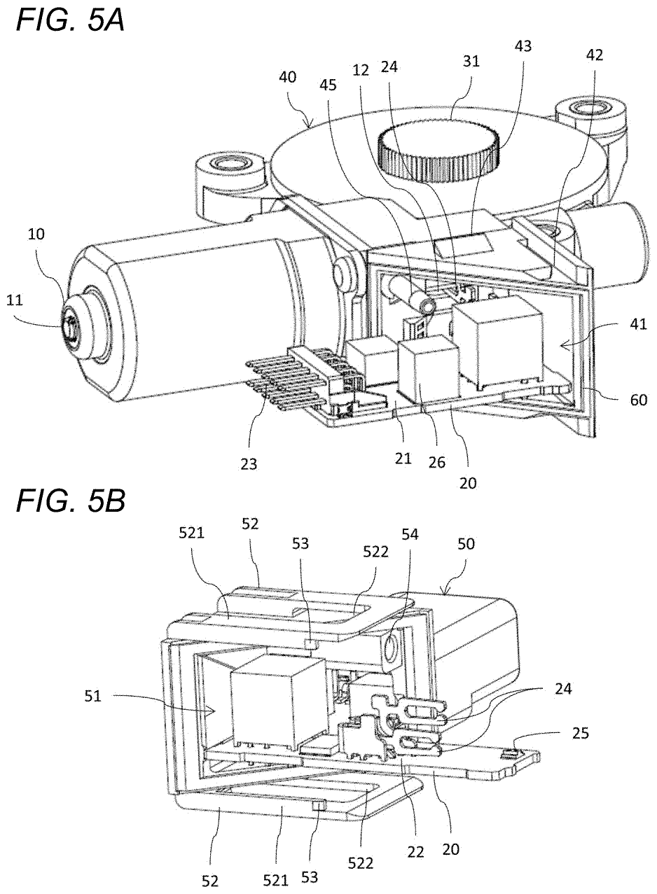

The storage portion 40 includes an alignment rod 45 projecting from the storage portion opening 41 in a direction orthogonal to the rotating shaft 11 on a plane perpendicular to the final output shaft 31 (FIGS. 3A to 3C, 5A, and the like), and the connector storage portion 50 includes an alignment hole 54 at a position corresponding to the alignment rod 45 as a hole recessed in the same direction (FIGS. 4A, 4B, 5B, and the like). When attaching the connector storage portion 50 to the storage portion 40, the alignment rod 45 is inserted into the alignment hole 54 to facilitate the alignment of the two.

On the printed circuit board 20, the connector 23 for receiving electric power from the outside, the electronic component 26 for driving the electric motor 10 from the electric power, two terminals 24 for supplying the driving electric power to the electric motor 10, and a rotation detection sensor 25 for detecting rotation of the rotating shaft 11 are mounted. The connector 23 is configured to be connectable to the connector cable for receiving power supply from the outside and transmitting and receiving signals to and from the outside. The electronic component 26 is an electrical component such as capacitors and semiconductors.

Each terminal 24 is formed in a tuning-fork shape, and in a case where the printed circuit board 20 is attached to the storage portion 40, the terminals 24 are electrically connected so as to sandwich the plate-like electrode 12 of the electric motor 10. The rotation detection sensor 25 is, for example, a Hall element that detects changes in the magnetic field, and is disposed so as to be in the vicinity of the magnet fixed to the rotating shaft 11 when attached. The rotation detection sensor 25 obtains rotation information such as the rotation speed and rotation direction of the rotating shaft 11.

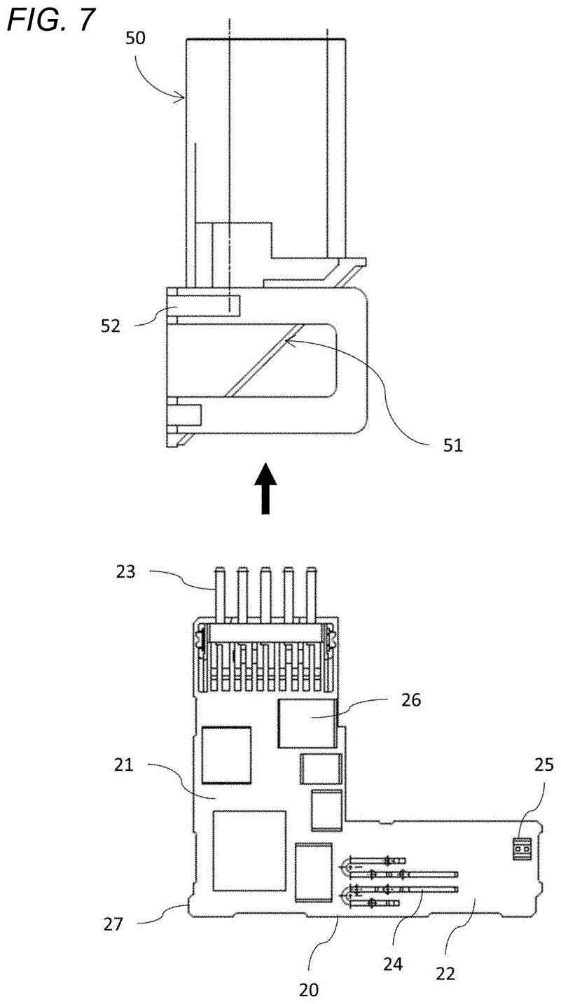

The printed circuit board 20 has a substantially L-shaped plate shape, and has a rectangular shape elongated in the vertical direction in FIG. 7, and in a case where the connector storage portion 50 is attached to the storage portion 40, is configured with a first portion 21 in which the rotating shaft 11 is parallel to the longitudinal direction of the rectangle on a plane perpendicular to the final output shaft 31 and a second portion 22 extending substantially at right angles to the longitudinal direction from the lower end of the first portion 21 toward the rotating shaft 11. The connector 23 and the electronic component 26 are disposed on the first portion 21, and the connector 23 is disposed on the upper end of the first portion 21.

The terminals 24 and the rotation detection sensor 25 are disposed on the second portion 22, the terminal 24 is disposed near the first portion 21, and the rotation detection sensor 25 is disposed at the end portion of the second portion 22. When attached, the end portion of the second portion 22 extends to the vicinity of the rotating shaft 11 and mounts the rotation detection sensor 25 thereon. As a result, the single printed circuit board 20 can have a plurality of functions, and miniaturization is possible. In a case where the connector storage portion 50 is attached to the storage portion 40, the first portion 21 is roughly housed in the connector storage portion 50, and the second portion 22 is roughly housed in the storage portion 40. A portion corresponding to the top portion of the L shape (the portion where the first portion 21 and the second portion 22 are connected) is positioned inside the connection portion 70.

As described above, since the printed circuit board 20 has a roughly L shape configured with the first portion 21 parallel to the rotating shaft 11 and the second portion 22 extending from the first portion 21 toward the rotating shaft 11, and the connection portion 70 between the connector storage portion 50 for housing the connector 23 mounted on the printed circuit board 20 and the storage portion 40 for housing the electric motor 10 is inclined with respect to the rotating shaft 11, there is provided an electric motor module 100 that can be miniaturized by suppressing the expansion of the power passing through the gear 30 from the electric motor 10 on a plane perpendicular to the final output shaft 31. That is, compared to the case where the printed circuit board is simply rectangular, the L-shaped printed circuit board makes it possible to shorten the distance from the gear 30 to the connector 23 in the direction orthogonal to the rotating shaft 11 on a plane perpendicular to the final output shaft 31.

The printed circuit board 20 includes a positioning protruded portion 27 that fits the positioning recessed portion 56 of the connector storage portion 50 at the outer end portion in the longitudinal direction of the first portion 21. As a result, when inserting the printed circuit board 20 into the connector storage portion 50 for attachment, it is possible to easily attach the same.

The mounting portion 52 is used to attach the connector storage portion 50 to the storage portion 40, and attaches the connector storage portion 50 to the storage portion opening 41 from a direction orthogonal to the rotating shaft 11 on a plane perpendicular to the final output shaft 31. In the present embodiment, the mounting portion 52 is made of resin, and is configured with an extension portion 521 extending from the connector storage portion 50 toward the storage portion 40 across the connection portion 70, and a snap fit including a hanging portion 522 hanging on a part of the storage portion 40 at the tip portion of the extension portion 521. A part of the storage portion 40 is formed as a projection 43 at a position that fits the hanging portion 522.

The mounting portion 52 (snap fit) extends in a direction orthogonal to the rotating shaft 11 on a plane perpendicular to the final output shaft 31. In the present embodiment, the mounting portion 52 extends from the connector storage portion 50 across the connection portion 70 toward the storage portion 40, but conversely, may extend from the storage portion 40 to the connector storage portion 50 across the connection portion 70. The hanging portion 522 hangs on the projection 43, but may hang on a recessed portion instead of the projection 43.

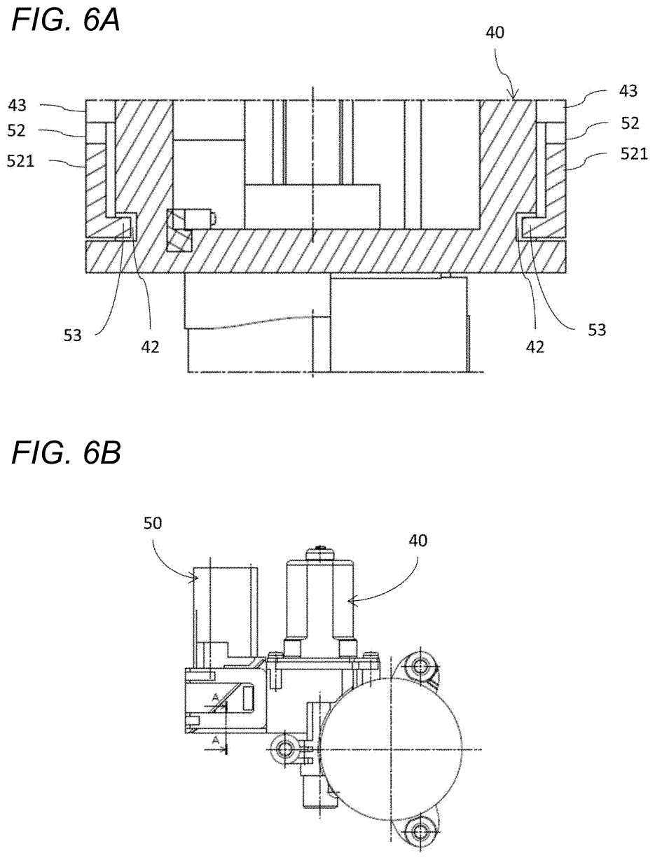

The extension portion 521 has elasticity that functions as a snap fit, and the extension portion 521 bends in the process of attachment, and the hanging portion 522 climbs over the projection 43, and after climbing over, returns and hangs on the projection 43. Thereby, the connector storage portion 50 is attached to the storage portion 40. As shown in FIG. 6A, the extension portion 521 includes a linear projection 53 inside, and the storage portion 40 includes a groove 42 that fits the linear projection 53 on the side surface thereof.

In a case where the mounting portion extends from the storage portion 40 across the connection portion 70 toward the connector storage portion 50, the connector storage portion 50 has a groove on the side surface thereof that fits the linear projection. When the linear projection 53 is provided on the extension portion 521, the elastic modulus of the extension portion 521 is increased. In this way, by providing the linear projection 53 in the snap-fit elastic portion of the mounting portion 52 and providing the groove 42 that fits in the position corresponding to the linear projection 53, it is possible to easily assemble and to firmly attach after assembling.

The linear projection 53 formed inside the extension portion 521, and the groove 42 formed on the outer surface of the storage portion 40 from the edge portion of the storage portion opening 41 toward the rotating shaft 11 so as to fit the linear projection 53 are fitted to each other from the time of attachment, and are firmly fitted even after attachment. Thus, the linear projection 53 and the groove 42 are fitted together during and after attachment. After the storage portion 40 and the connector storage portion 50 are attached, a force is applied to the connector storage portion 50 when the connector cable is attached to the connector 23, and forces in various directions (forces in three-dimensional directions and torsional forces in each direction) are applied to the mounting portion 52. However, as a result, it is possible to provide a mounting structure that can be assembled easily in assembling, in which two storage portions do not fall off easily even if a force is applied after being assembled, that is, a mounting structure that is resistant to so-called twisting.

In the storage assembly (electric motor module 100) in which two storage bodies of a storage body (storage portion 40) for housing the electric motor 10 or the like and a storage body (connector storage portion 50) for housing the connector 23 or the like are connected, a linear projection is formed in an extension portion extending from one storage body toward the other storage body, and a groove that fits the linear projection is provided in the other storage body, thereby providing a storage assembly that is assembled easily in assembling, in which two storage bodies do not fall off easily even if force is applied after being assembled.

The electric motor 10 and the gear 30 are assembled, and a method of assembling the storage portion 40 housing the electric motor 10 and the gear 30, the connector storage portion 50, and the printed circuit board 20 will be described. As shown in FIG. 7, the printed circuit board 20 is inserted from the first portion 21 on which the connector 23 is mounted into the connector storage portion opening 51 that becomes the inclined connection portion 70. At this time, the edge of the first portion 21 in the longitudinal direction is sandwiched in the slide groove 55 inside the connector storage portion 50, and the connector 23 is inserted deep to be fitted into the connector storage portion 50 while being slid. When the positioning protruded portion 27 of the printed circuit board 20 reaches the positioning recessed portion 56, the insertion is stopped. As a result, the printed circuit board 20 is attached to the connector storage portion 50 and the first portion 21 is housed in the connector storage portion 50.

In a case where the connector storage portion opening is not inclined and is provided on the side surface of the storage portion of the connector storage portion, it is necessary to insert the L-shaped printed circuit board 20 while rotating the same through the opening, but the connector storage portion opening 51 is inclined as in the present embodiment, and the insertion direction becomes linear and it is possible to easily assemble.

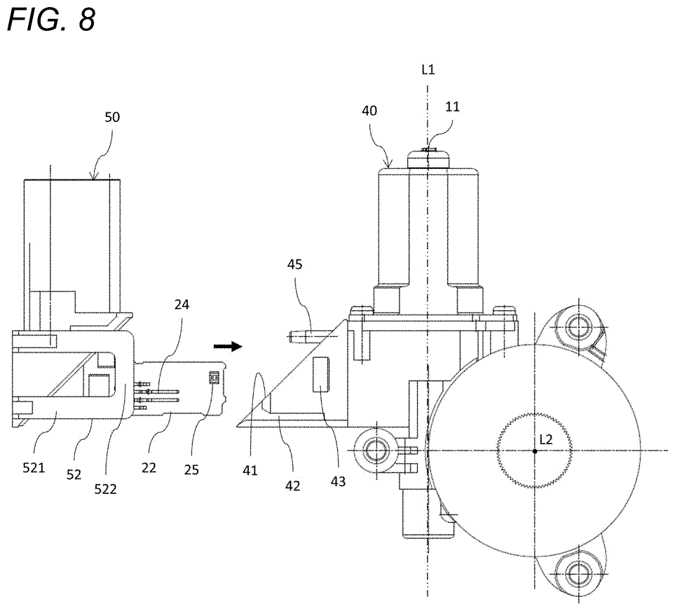

Next, as shown in FIG. 8, while aligning the alignment hole 54 so that the alignment hole 54 is inserted into the alignment rod 45, the second portion 22 of the printed circuit board 20 in which the first portion 21 is housed in the connector storage portion 50 is inserted into the storage portion opening 41 inclined from a direction orthogonal to the rotating shaft 11 on a plane perpendicular to the final output shaft 31. At this time, the planar direction of the printed circuit board 20 is made to coincide with the direction of the plane perpendicular to the final output shaft 31. When inserted to some extent, the linear projection 53 inside the mounting portion 52 and the groove 42 formed on the side surface of the storage portion 40 are aligned, and further inserted as the both are slid.

Although the terminals 24 mounted on the second portion 22 project from the printed circuit board 20, but the mounting portion 52 provided at a portion extended downward in a triangular shape so as to form the inclined connector storage portion opening 51 functions also as a portion for protecting the terminals 24 in the process of insertion.

In the extension portion 521 of the mounting portion 52, the extension portion 521 bends and lifts upward when the tip of the hanging portion 522 starts to abut on the slope of the projection 43. When inserted, the hanging portion 522 climbs over the projection 43, and after climbing over, the bending returns and the inside of the hanging portion 522 hangs on the projection 43. At this time, the connector storage portion opening 51 and the storage portion opening 41 are brought into contact with each other with the sealing 60 interposed therebetween. As a result, the connector storage portion 50 is attached to the storage portion 40, and the electric motor module 100 is completed.

The tuning-fork shaped terminals 24 pinch the plate-shaped electrode 12 in the process of attaching the connector storage portion 50, and is electrically connected to the electrode 12 when the hanging portion 522 of the mounting portion 52 engages the projection 43. Since the end portion of the second portion 22 is inserted through the opening and extends to the vicinity of the rotating shaft 11, and includes the rotation detection sensor 25 therein, the rotation detection sensor 25 can detect the rotation of the rotating shaft 11.

According to this, since the printed circuit board 20 has a roughly L shape configured with the first portion 21 parallel to the rotating shaft 11 and the second portion 22 extending from the first portion 21 toward the rotating shaft 11, the connection portion 70 between the connector storage portion 50 for housing the connector 23 mounted on the printed circuit board 20 and the storage portion 40 for housing the electric motor 10 and the gear 30 is inclined with respect to the rotating shaft 11, and the connector storage portion 50 housing the first portion 21 is attached to the storage portion opening 41 in a direction orthogonal to the rotating shaft 11 from the second portion 22, it is possible to provide an easy-to-assemble method for assembling the electric motor module 100. Further, by providing the mounting portion 52 having a structure for attaching the connector storage portion 50 to the storage portion opening 41 from the direction orthogonal to the rotating shaft 11, it is possible to provide an easy-to-assemble method for assembling the electric motor module 100.

The present invention is not limited to the described embodiments and can be implemented by a configuration in a scope that does not depart from the content described in each section of the claims. That is, the present invention is mainly and particularly shown and described with respect to a specific embodiment, and those skilled in the art can make various modifications in the quantity and other detailed configurations with respect to the above-described embodiments without departing from the scope of the technical idea and the objects of the present invention.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. An electric motor module comprising:
an electric motor;
a printed circuit board on which a connector for receiving electric power from an outside and a terminal for supplying the electric power to the electric motor are mounted;
a gear that performs conversion such that an axial direction of an output shaft extends in a direction orthogonal to an axial direction of a rotating shaft of the electric motor;
a storage portion that houses at least the electric motor and the gear; and
a connector storage portion that houses at least the connector, the connector storage portion being attached to an opening of the storage portion,
wherein a connection portion between the opening and the connector storage portion is inclined with respect to the rotating shaft on a plane perpendicular to the output shaft,
wherein the printed circuit board includes: a first portion parallel to the rotating shaft on the plane perpendicular to the output shaft; and a second portion extending from one end of the first portion toward the rotating shaft,
wherein the connector is disposed at another end of the first portion, and
wherein the terminal is disposed in the second portion.

2. The electric motor module according to claim 1,
wherein a direction of insertion into the connector in the connector storage portion and the rotating shaft are parallel to each other.

3. The electric motor module according to claim 1,
wherein an end portion of the second portion includes a sensor inserted through the opening and extends to a vicinity of the rotating shaft, the sensor being configured to detect rotation of the electric motor.
